(19) United States
(12) Patent Application Publication
(10) Pub. No.: US 2010/0179982 A1
(43) Pub. Date: Jul. 15, 2010

(54) METHOD FOR AUDITING THE DATA OF A COMPUTER APPLICATION OF A TERMINAL

(75) Inventor: Francois Colon, Marseille (FR)

Correspondence Address: HARNESS, DICKEY & PIERCE, P.L.C., P.O. BOX 828, BLOOMFIELD HILLS, MI, 48303, US

(73) Assignee: Miyowa, Marseille (FR)

(21) Appl. No.: 12/354,175

(22) Filed: Jan. 15, 2009

(51) Int. Cl. G06F 15/16

(52) U.S. Cl. 709/203

(57) ABSTRACT

The invention relates to a method for auditing data relating to the utilization of a computer application run in a terminal including the following steps:
the running of the application from a set of functions using the components of a framework;
the auditing of the components of the framework, and
the transmission of the results obtained from said auditing step to a remote server.

The method includes the following preliminary steps:
the prior labeling of each component of the framework;
the transmission to the terminal of a list of components of the framework to be audited, and
the integration of an auditing instruction in at least one component of the framework.

In addition, said step of auditing includes a sub-step of activation of the auditing instruction when the component of the framework wherein said instruction is integrated, with the component used being included in said list so as to obtain said results including the labels of the audited components associated with the utilization which is made thereof.

### TECHNICAL FIELD OF THE INVENTION

The invention relates to a method for auditing data of a computer application of a terminal. The present invention relates to the field of methods making it possible to retrieve data relating to the utilization of a computer application aboard a terminal, with a view to analyzing the activity of the users of said application and/or analyzing malfunctions which can happen upon the implementation of said computer application.

### BACKGROUND

The analysis of data relating to the utilization of an application consists in auditing information relating to such data from procedures implemented by developers consisting in writing beforehand auditing instructions within said application in order to retrieve information relating to the utilization thereof. The latter are then analyzed in real time or afterwards by other computer systems in order to give results in the form of processable data. This information relating to the utilization of an application can be used by marketing teams in order to better understand the utilization which is made of computer applications downloaded on many terminals: consulted internet sites, types of purchases made, types of music played, etc. For example, knowing the activities of the users, a marketing department will be able to target the advertisements which will be sent to their computer terminals: for a first user, advertisements relating to sports will be sent whereas for another user, advertisements relating to music will be sent, etc.

Any modification in what must be audited requires a modification of all or part of the computer application. The developers must then analyze what must be collected, then write the auditing instructions at the correct locations. For example, if a user visits an internet site devoted to sports for an hour and then visits an internet site devoted to music for five seconds, and if specific instructions are not provided, the marketing department will have no concrete information allowing to know that the user prefers sport to music and that it may not be useful to send him or her, advertisements relating to music. Such mechanisms provide for the integration of such applications on a terminal of the standard computer type, since the computing power of a standard computer allows efficient processing, by using the power of the processor and the speed and space available on the storage units as well as the increasing velocity of the networks which makes it possible to consider sending data via the same networks. However, a general problem is raised as to the implementation of a method for auditing data in a terminal having low efficient material resources such as a mobile terminal, since the constraints are more numerous and thus the auditing of information relating to data about the utilization of the application becomes more complex.

As a matter of fact, there are several problems which the developer of a computer application is confronted to, as he wishes to know what the utilization by the users of such application is. One of these problems relates to the constraints of the processor power. As a matter of fact, one application containing too many instructions relating to the analysis of the utilization will soon raise problems of efficiency. In addition, too rich information will soon create problems as regards the storage and/or the sending thereof to a centralized server.

Eventually, a modification in the auditing information requires the updating of the computer application, which is extremely prejudicial on a mobile terminal because of the low speed of the network and the inherent difficulty of such handling for persons who are not skilled in the art. Then, constraints exist as regards the storage space. One application operated on the mobile terminal does not always have much storage space to store the traces of the utilization which is made thereof. Constraints regarding the speed of the network also exist. The analysis of the data relating to the utilization of the application will not be carried out on the mobile terminal itself, but rather in a centralized way.

The only method for retrieving such data relating to the utilization of the application to a centralized server consists in sending such data via the network. Now, the mobile network is slow and liable to be interrupted at any time. Eventually, constraints exist as regards the specificity of certain mobile terminals. A computer application developed on a mobile terminal will not necessarily be processable on another mobile terminal. The same is true for all the developments on mobile platforms which use various OS and various Java implementations (or any other: C++, Brew, Symbian, Linux, Android, iPhone), associated with security restrictions imposed by the constructors or the operators. Then, the development must be tested and, if need be, reviewed, if it is desired that it should be processable on another terminal.

Simpler techniques make it possible to retrieve data relating to the utilization of computer applications which are described more particularly in the documents FR 2,868,177 or US 2005/0243854 relating to a method for analyzing the data of a mobile telephone described in the document. From document US 2007/0038974, a method is more particularly known, wherein a set of functions use the components of a framework to run a computer application integrated in the computer, said components being audited so as to define the utilization which is made thereof, the results of the audit being transmitted to a remote server to be analyzed. This method is implemented through a tool making it possible to define the components of a framework associated with a computer application incorporated in the computer which would be sufficient to run the same application on a mobile telephone.

It should be reminded that a computer application (mails, blog, internet surfing), integrated in the computer terminal is combined to a specific framework. A framework is a notion of computer technique well known to the person skilled in the art. While referring to FIG. 1, a framework CADR could be linked to a structured and organized library of components C1, C2, C3, C4, C5 predefined by the developers. Such components C1, C2, C3, C4, C5 can be graphic elements, objects, computer tools, programs, methods, etc. The components of a framework are structured and organized to be used while interacting with each other and could be linked to “software bricks”. A framework supplies an environment wherein the components can be reused from one computer application to another. It supplies enough components and it is rigorous enough to be able to produce an advanced, easy to maintain computer application.

The tool described in the document US 2007/0038974 makes it possible to analyze in details the utilization of the components of the framework. This auditing technique founded on the analysis of the components of a framework makes it possible to get rid of the above-mentioned problems related to the tedious writing of instructions within a computer application proper. However, one the main drawbacks of such a solution is that it is not adapted to the audit of information carried out for marketing purposes, for example. As a matter of fact, in the document US 2007/0038974, all the components of the framework are audited whereas in practice, a marketing department only needs to know the utilization of some of them. Such a solution requires having a computer with important hardware resources to meet the constraints of power, storage space and network capacity, as the quantity of information relating to the utilization of the application to be processed and transferred to a remote server is much too important.

### SUMMARY

The invention aims at remedying the problems related to the technical difficulties relating to the important consumption of hardware resources upon the auditing of data relating to the utilization of an application run in one terminal. The invention makes it possible to improve the portability and to limit the consumption of resources like data analysis mechanisms by a selective and adaptable processing of the components of a framework.

More precisely, the invention aims at a method for auditing data relating to the utilization of a computer application run in a terminal, said application being combined with a framework composed of a set of components, said method including:
the running of the application from a set of functions using the components of the framework;
the auditing of the components of the framework, and
the transmission of the results obtained from the auditing step to a remote server so that the results are analyzed.
   The method further includes the following preliminary steps:
the prior labeling of each component of the framework;
the transmission to the terminal of a list of components of the framework to be audited, and
the integration of an auditing instruction into at least one component of the framework.

In this method, said the auditing step includes a sub-step of activation of the auditing instruction (Adt), when the component of the framework, wherein said instruction is incorporated, is used and included in said list, so as to obtain said results including the labels of the audited components associated to the utilization which is made thereof. Furthermore, this auditing step includes a sub-step of activation of the auditing instruction, said auditing instruction being activated only when the component of the framework wherein said instruction is integrated is used and included in said list, so as to obtain said results including the labels of the audited components associated with the targeted utilization. By drawing a list of the components to be audited, a marketing department, a technical department and/or any other entity now has the capacity of selecting among all the components of the framework, the only components of which it wishes to know the activity. And the integration of one auditing instruction inside the components makes it possible to very simply control the audit when the selected components are used, without it being necessary to modify the computer application. The invention thus uses a specific framework which makes it possible for developers to concentrate on the logic of the computer application thereof and not on auditing instructions.

According to particular embodiments:
the list of the components to be audited is generated in a remote server which the computer terminal must be connected to to implement the computer application;
the list of the components to be audited is transmitted to the computer terminal upon the initial downloading of the computer application;
upon the initial downloading of the computer application, the list of the components to be audited is empty or includes components noted by default;
the list of the components to be audited is transmitted to the computer terminal after the latter is connected to the remote server, making it possible to implement the computer application;
the list of the components to be audited is generated in the remote server which the results of the auditing are transferred to;
the list of the components to be audited contains auditing instructions associated with each of said components;
the list of the components to be audited is updated in a remote server and transmitted to the computer terminal after each updating;
the results of the auditing are previously stored in a storage area and/or a file of the computer terminal prior to be transmitted to the remote server;
the transfer of the results of the audit from the storage area and/or of the file of the computer terminal to the remote server is commanded by a request emitted from said server;
the request emitted by the server contains a restricted list of framework components for which the results must be transmitted;
the transfer the results of the audit from the storage area and/or the file of the computer terminal to the remote server is commanded as soon as the storage capacity of said storage area and/or said file reaches a critical threshold;
the transfer of the audit results from the storage area and/or the file of the computer terminal to the remote server is commanded upon each connection of said terminal to said server, and
the transfer of the audit results from the storage memory and/or the file of the computer terminal to the remote server is commanded at a given time defined by a clock integrated in said terminal.

### BRIEF DESCRIPTION OF THE FIGURES

Other characteristics and advantages of the invention will appear upon reading the following description and referring to the appended Figures which are illustrated:

FIG. 1 is a schematic illustration of the main steps of one embodiment of the invention; and

FIG. 2 is a flow diagram of the main steps of an embodiment according to the invention.

For clarity purposes, identical or similar elements are referenced by identical reference characters on all the figures.

### DETAILED DESCRIPTION

The method which is the object of the invention makes it possible to audit information relating to the utilization of a computer application integrated in a computer terminal. In a non limitative way, this audit is preferably intended for marketing departments wishing to analyze the activity of users of computer terminals with a view to targeting the commercial advertisements which will be sent thereto. This audit may also be used by other entities and more particularly technical departments wishing to analyze the malfunctions which may occur upon the implementation of a computer application.

The computer terminals used for the implementation of the invention can be fixed terminal of the computer (PC) type or mobile terminals such as mobile telephones, devices of the personal digital assistant (PDA) type, devices of the BlackBerry® type or fixed terminals such as PC computers. Such computer terminals incorporate one or several computer applications. The computer applications to be analyzed are typically those usually provided to the user of a computer terminal: connection to internet, instant mail, mail, blog or any other.

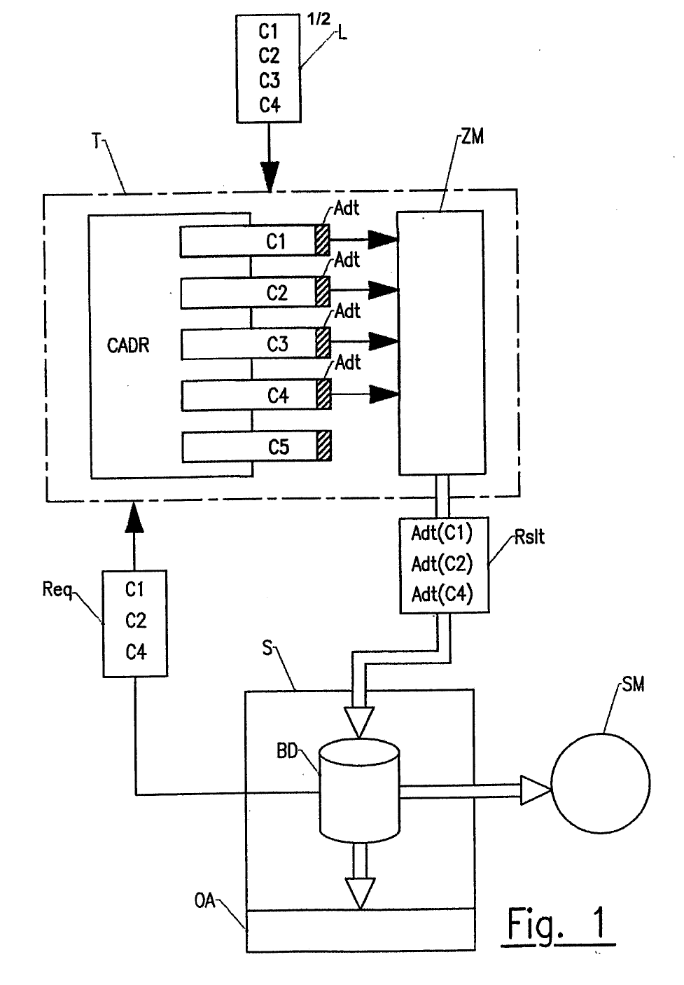

This can also relate to not so current computer applications and/or new ones (for example updating) the designers of which wish to know the utilization by the users thereof. According to the invention and as shown in FIG. 1, each computer application integrated in a computer terminal T is combined with a framework CADR composed of a set of components C1, C2, C3, C4, C5 making it possible to run said application. Each framework can be associated with one or several computer application(s).

In FIG. 1, only five components are shown but it should be noted that a framework can have a great number thereof. These components C1, C2, C3, C4, C5 can be graphic elements, objects, computer tools, programs, methods, functions, etc. Generally speaking, a set of functions or computer commands uses the components of the framework to run a computer application. The components are thus called for, for implementing the application.

For example, a function will make it possible to display tabs on the screen of a computer terminal and to display under the tab: a text area, a drop-down menu, buttons. Another function will make it possible to write a text in the text area. Another function will make it possible to wind/unwind the drop-down menu. Again another function will make it possible to activate the buttons. Other functions will describe the manner in which the calls for the operations system of the computer terminal must be implemented or the way in which the calls for the libraries must be made, etc.

According to the invention, each component of the framework is recognized by means of a unique identifier. Such labeling of the components of the framework makes it possible to finally analyze the utilization thereof. As a matter of fact, if the functions acting on the components are saved without them being identified, the same function which applies to two different components will not be saved in a different way. For example, the labeling of the components will make it possible to save the display of a tab and the display of a text area in two different ways: the “display” function being the same but applying to different “tab” and “drop-down menu” components.

Other components of the framework which are not displayed but which are interesting for an audit can also bear an identifier. Such labeling may vary according to the computer application using the framework. It is particularly advantageous to class and/or give a priority to the identifiers of the components of the framework to finely analyze the call therefor. For example, the identifiers of the graphic elements displayed can be connected to the identifiers of the graphic elements including the previous ones. As a matter of fact, the graphic elements which are displayed under a first tab may not be the same as those which are displayed under another tab.

For example, the components of the framework could be identified as followings: C1, C1:C2, C1:C3, C3:C4, C3:C5 which could indicate that the component C1 contains the components C2 and C3 and that the component C3 contains the components C4 and C5. This classification of the components of the framework also makes it possible to save their call differently. Further to this classification, a tree of identifiers is obtained which shows the architecture of the framework and the computer application thus obtained.

It should be noted that the same component has a different identifier depending on the computer application which it is used in. The framework is capable to manage this hierarchy, the developer not needing to think of creating it: he/she will simply have to give a name to the various components. The components of a framework are usually in the form of a series of processable codes.

According to the invention, an auditing instruction (i.e. one or several additional line(s) of codes) is integrated in each component of the framework or in some of them. This way, when one component of the framework integrating an auditing instruction is called for by the computer application, the audit of said component will be automatically activated. The auditing instructions making it possible to record not only the call for a component (the applied functions) but also the label of the component given by the developer.

Some additional information can be audited such as the display time of a component, the willful activation of a component by the user, the location where the results are stored, etc. Generally speaking, the instructions of said audit make it possible to save the utilization of a component of the framework and more precisely the real utilization of a user which handles a graphic interface. When the computer application is launched and when the audit is completed, a series of information will be available, for example in the form of a list.

Table 1 hereinunder illustrates an exemplary result of audit.

TABLE 1

| Audited component | Auditing results |
|---|---|
| C1 (ex: tab) | Display time = 5 s, 2 s, 7 s |
| C1:C2 (ex: text area) | Subscription = Yes |
| C1:C2 (ex: drop-down menu) | Unwinding = No |
| C3:C4 (ex: 1st button) | Number of activations = 0 |
| C3:C5 (ex: 2nd button) | Number of activations = 5 |

In practice, the developers mention in the code of the components of the framework how the results of the audit will be managed. They compile the computer application with the framework thus generated so as to create a processable application. It will also be possible to provide a separately compiled computer application which uses a separately compiled framework.

The auditing instructions can be activated in a centralized way by parameters which can be modified without recompiling the computer application nor the framework. A file existing in the computer terminal can, for example, be read for retrieving such auditing instructions. A call on a URL can thus return the required instructions. A special function (function of initializing audits) can be called for by the computer application, so that the framework retrieves such auditing instructions.

During the running of the computer application, the components of the framework are called for. The computer application then triggers the call for the function of audits initialization. The framework triggers such initialization by reading a file or of a network call according to the default parameters. Therefore, the computer terminal calls for a remote server (web server, instant message server, mail server, blog server) by transmitting it a request for connection including an identification of the computer application to be implemented, as well as the identification of the user.

The remote server which will receive the request for connection will recognize the computer application requesting such auditing parameters. The distant server does have a database which contains the references of the computer applications which are liable to be the object of audits. The server also has audit instructions to be returned for a given computer application.

Then, the server can also return specific audit instructions for a computer application associated with a particular user. The server will read the auditing instructions in its database and will transmit them to the computer terminal in answer to the request for connection. The computer terminal retrieves such auditing instructions to integrate them into the component of the framework.

While referring to the example in FIG. 1, all the components C1, C2, C3, C4, C5 of the framework CADR (or some of them) integrate an audit instruction Adt. When the computer application is launched and a component to be audited is called for by said application (i.e. a function uses the component for running the application) then the audit of the component is executed. According to the invention, a list L of the components to be audited is transmitted to the computer terminal T prior to the launching of the computer application. The list L, in addition to the names of the components to be audited, may contain the auditing instructions associated with each of said components.

This list is emitted from a remote server. In practice, the list L is in a format which is invisible for the user (for example in the form of a SMS, codes or pieces of codes) and is emitted according to a conventional protocol. While referring to the example illustrating the invention, the list L contains the following components: C1, C2, C3, and C4. This list L makes it possible to activate the auditing instruction only if the component of the framework in which said instruction is integrated is used and belongs to said list.

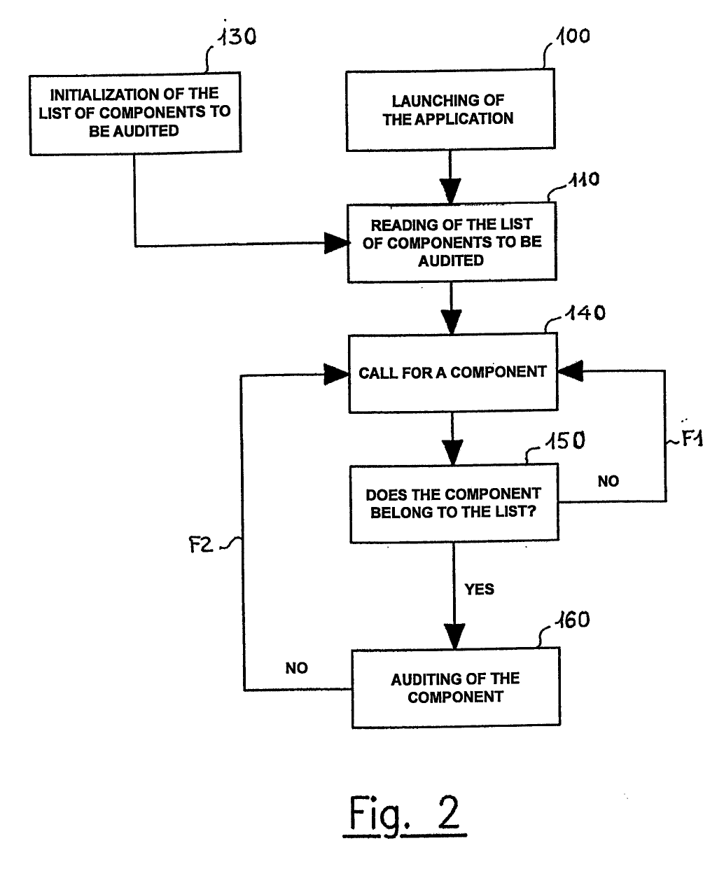

As illustrated in FIG. 2, when the computer application is launched (step 100), the various components will be called for and read (step 110), i.e. functions will act thereon, from the list of components (step 130). Upon each call for a component C1, C2, C3 or C4 (step 140) belonging to the list L (checking at step 150), the auditing instruction Adt associated thereto will in principle be activated (step 160) and the framework will record the utilization which is made thereof. If the component does not belong to the list L (arrow F1), or if the audit of the component is not requested by an instruction (arrow F2), the application returns to the calling step (step 140). According to the auditing instructions, the framework will keep in memory the results of the audits by storing them locally in a storage area ZM and/or in a file of the terminal T and/or it can trigger a call to a remote server to send them thereto.

The other component called for by the computer application but which do not belong to the list L will not be audited. By drawing up a list of the components of the framework which must be audited, a marketing department (and/or any other entity) now has the possibility of selecting, among all the components of the framework, the only components the activity of which it wants to know. The list L of the components of the framework which must be audited is advantageously generated in a remote server, which can be either the server S which the results of the audit are transferred to, or a server which the terminal must be connected to to implement the computer application (web server, instant message server, mail server or blog server).

Advantageously, the list L of the components of the framework which must be audited is updated in this remote server and transmitted to the computer terminal T, after each updating. The list L can be transmitted to the computer terminal T when the latter is connected to a remote server making it possible to implement the computer application. Typically, to launch the computer application, the terminal T sends beforehand to the server a request for connection. The latter is associated with an identifier of the user of terminal T.

After checking the identifier, the server transmits the list L of the components to be audited to the terminal T. In an alternative embodiment, the list L could be transmitted to the terminal T upon the initial downloading of the computer application. In this later case, the list L can be empty (and be completed during the subsequent updating) or include components noted by default. At any time, the remote server in charge of retrieving the results of the audit can send a command to the computer terminal to have it call back the command initializing the audits (step 120). The results of the audit Rslt including the labels of the components of the framework associated with the utilization which is made thereof are stored in a storage area ZM and/or a file of the computer terminal T or directly sent to a remote server S to be analyzed in real time or subsequently.

A mixed solution can also be considered to manage the instability of the network or solve a problem relating to the storage space. The transfer of the results of the audit Rslt from the terminal T up to the server S is made in a standard format according to a conventional protocol. The latter may include a database BD wherein all the results of the audit are stored, with said base being accessible to a marketing department SM or any other entity which will be in charge of the analysis.

The server S will also be directly provided with an analysis tool OA. Once collected at the desired place, the results of the audit can be processed by statistic software or a TRM. In the case when the results of the audit Rslt are previously stored in a storage area ZM and/or in a file of the computer terminal T, the transfer of said results to the server S can be commanded by a request Req emitted from said server. Such request Req is emitted in a standard format and under a standard protocol. The request Req can contain a restricted list of components of the framework for which the results must be transmitted.

For example, if the components C1, C2, C3, C4 and C5 have been audited 25, the results relating to the components C1, C2 and C4 only can be transmitted to the server S. Basically, this makes it possible, for example, to audit all the graphic elements which appear on the screen of the terminal T and to transfer only the results of some of such graphic elements which are required at a given time by a marketing department. The immediate effect thereof is to limit the quantity of data which can be stored or transferred while leaving the possibility of activating them at any time by means of another request. The latter can be sent through a call on the network or by reading regularly a file which is liable to be modified by another process and thus to contain instructions for saving results of the audit.

In an alternative embodiment, the transfer of the results from said audit Rslt from a memory area (ZM and/or the file of the computer terminal T to a server S is commanded, as soon as the storage capacity of said storage area and/or said file reaches a critical threshold, for example every X results collected or every Y bytes stored. The invention is not limited to the exemplary embodiments described and illustrated therein. In addition, it is not limited to these exemplary executions nor to the described variants. As a matter of fact, the transfer of the results of the audit Rslt can also be commanded each time the server T is connected to the server S. The transfer of the results of the audit Rslt can be commanded at a given time, defined by a clock integrated in the terminal T, for example every X minutes or seconds.

1. A method for auditing data relating to the utilization of a computer application run in a terminal, said application being combined with a framework comprising a set of components, said method comprising:
the running of the application from a set of functions using the components of the framework;
the auditing of the components of the framework;
the transmission of the results obtained from said auditing step to a remote server so that the results are analyzed;
the prior labeling of each component of the framework;
the transmission to the terminal of a list of the components of the framework to be audited;
the integration of an auditing instruction into at least one component of the framework; and
said auditing step includes a sub-step of activation of the auditing instruction, when the component of the framework, wherein said instruction is incorporated, is used and included in said list, so as to obtain said results including the labels of the audited components associated to the utilization which is made thereof.

2. A method according to claim 1, wherein the list of the components to be audited is generated in a remote server which the computer terminal must be connected to to implement a computer application.

3. A method according to claim 2, wherein the list of the components to be audited is transmitted to the computer terminal upon the initial downloading of the computer application.

4. A method according to claim 3, wherein upon the initial downloading of the computer application, the list of the components to be audited is empty or includes components noted by default.

5. A method according to claim 2, wherein the list of the components to be audited is transmitted to the computer terminal after the latter is connected to the remote server making it possible to implement the computer application.

6. A method according to claim 1, wherein the list of the components to be audited is generated in the remote server which the results of the audit are to be transferred to.

7. A method according to claim 6, wherein the list of the components to be audited also contains auditing instructions associated with each of said components.

8. A method according to claim 1, wherein the list of the components to be audited is updated in the remote server and transmitted to the computer terminal after each updating.

9. A method according to claim 1, wherein prior to being transmitted to the remote server, the results of the audit are stored in a storage area and/or a file of the computer terminal.

10. A method according to claim 9, wherein the transfer of the results of the audit, from the storage area and/or the file of the computer terminal to the remote server is commanded by a request emitted by said server.

11. A method according to claim 10, wherein the request emitted by the server contains a restricted list of components of the framework for which the results must be transmitted.

12. A method according to claim 9, wherein the transfer of the results of the audit from the storage area and/or the file of the computer terminal to the remote server is commanded as soon as the capacity of storage of said storage area and/or said file reaches a critical threshold.

13. A method according to claim 9, wherein the transfer of the results of the audit from the storage area and/or the file of the computer terminal to the remote server is commanded upon each connection of said terminal to said server.

14. A method according to claim 9, wherein the transfer of the results of the audit from the storage area and/or the file of the computer terminal to the remote server is commanded at a given time defined by a clock incorporated in said terminal.
